(19) United States
(12) Patent Application Publication
(10) Pub. No.: US 2012/0171387 A1
(43) Pub. Date: Jul. 5, 2012

(54) Methods for Producing Extruded Body Reactors

(75) Inventors: Diane Kimberlie Guilfoyle, Painted Post, NY (US); James Scott Sutherland, Corning, NY (US)

(73) Assignee: CORNING INCORPORATED

(21) Appl. No.: 13/391,935

(22) PCT Filed: Aug. 31, 2010
(86) PCT No.: PCT/US2010/047200

§ 371 Date: Feb. 23, 2012

Related U.S. Application Data
(60) Provisional application No. 61/238,437, filed on Aug. 31, 2009.

(51) Int. Cl. B05D 3/06; B05D 7/22

(52) U.S. Cl. 427/510; 427/230

(57) ABSTRACT

A method is disclosed for plugging selected cells of a honeycomb monolith so as to form a fluidic reactor, the method comprising contacting selected cells of a honeycomb monolith with a melted or softened plug material, the material comprising at least one sinterable particulate and a binder, the binder comprising at least one thermo-setting component and at least one UV-radiation curable polymer, the contacting performed such that a portion of the material remains in contact with the selected cells and plugs the selected cells; cooling the melted or softened plug material such that the thermo-setting component sets; after cooling, irradiating the portion of the material so as to at least partially cure the radiation curable polymer; and after irradiating, sintering the portion of the material so as to remove the binder and so as to sinter the at least one sinterable particulate. A method of preventing bubble formation during the contacting process is also disclosed.

### PRIORITY

This application claims priority to U.S. Patent Application No. 61/238,437, filed Aug. 31, 2009, titled “METHODS FOR PRODUCING EXTRUDED BODY REACTORS”.

### BACKGROUND

The present invention relates in general to methods for plugging honeycomb extrusion monoliths to form reactors suitable for liquid-based and other reactions, and particularly to use of particular plugging materials, including a UV-curable component, and particular plugging methods, for sealing channels in monolith-based chemical reactors.

Techniques for fabricating low-cost continuous flow chemical reactors based on honeycomb extrusion technology have been presented previously by the present inventors and/or their colleagues, for example, as disclosed in EP publication no. 2098285, assigned to the present assignee. With reference to FIG. 1, in a reactor 10 of this type, fluid flows in millimeter-scale channels 22, 24 through a substrate 20. At least one path 28 is formed having periodic U-bends formed by machining end face regions of the reactor substrate 20 and then selectively plugging, with plugs or plugging material 26, as shown in the perspective cut-away of FIG. 1. This approach allows the creation of long, large volume serpentine fluid channel(s) that constitute path(s) 28 formed within the honeycomb monolith extending at least in part (at the U-bends) in a direction perpendicular to the cells of the monolith. Such paths 28 are useful for reactants, and the many millimeter-scale channels or cells 22 parallel to the extrusion direction adjacent to the paths(s) 28 are useful for heat flowing exchange fluids 30 through. Alternatively, reactant 30 may flow parallel to the extrusion direction in the open channels or cells 22, while heat exchange fluid flows through adjacent path(s) 28. This second configuration is preferred when lowest pressure drop is required along the reactant channel. As an alternative to serpentine channels, the walls separating the successive cells in the path(s) 28 can be removed completely to the depth of the opposite-face plugs, as shown and described for example in the path 28 need not follow the original direction of the channels of the substrate 18 at all, but may pass in a direction perpendicular to the channels of the substrate in the form of a high-aspect ratio channel reaching from plugs 26 at one end to plugs 26 at the other end of the substrate 20, without the need of U-bends in the path 28. Such a structure is disclosed and described by the present inventor and/or colleagues in U.S. Pat. Publication No. 20100135873, assigned to the present assignee.

Where a serpentine path 28 is used, for reactant or process fluid and especially for heat exchange, pressure drop can be large. Even with the use of high-aspect ratio channels, especially when high heat exchange fluid flow rates are required to control extremely exothermic or endothermic reactions, desired internal operating pressures can be large.

The present disclosure describes a method by which robust, pressure resistant plugs may be formed reliably and repeatably and relatively efficiently.

### SUMMARY

One embodiment includes a method for plugging selected cells of a honeycomb monolith so as to form a fluidic reactor, the method comprising contacting selected cells of a honeycomb monolith with a melted or softened plug material, the material comprising at least one sinterable particulate and a binder, the binder comprising at least one thermo-setting component and at least one UV-radiation curable polymer, the contacting performed such that a portion of the material remains in contact with the selected cells and plugs the selected cells; cooling the melted or softened plug material such that the thermo-setting component sets; after cooling, irradiating the portion of the material so as to at least partially cure the radiation curable polymer; and after irradiating, sintering the portion of the material so as to remove the binder and so as to sinter the at least one sinterable particulate.

A further embodiment includes method for plugging selected cells of a honeycomb monolith so as to form a fluidic reactor, the method comprising providing a honeycomb monolith having a plurality of cells; masking selected ones of the cells of the monolith not to be plugged; contacting unmasked cells of the honeycomb monolith with a melted or softened plug material resting on a non-stick film supported on a refractory substrate having a volumetric heat capacity of not more than 1.55 J/(cm3·K) and a thermal conductivity of not more than 1.2 W/(m·K); and after contacting for sufficient time to push the plug material into the unmasked cells, immediately removing the refractory substrate.

By both of these embodiments, robust, pressure resistant plugs may be formed reliably and repeatably and relatively efficiently. Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective cut-away view of a portion of a reactor 10 of the type with which the present disclosure is concerned;

FIG. 2 is a cross-sectional view illustrating sealing problems discovered by the present inventors in certain reactors of the type shown in FIG. 1;

FIG. 3 is a cross-sectional view of a substrate being processed according to an embodiment of the present disclosure;

FIG. 4 is a cross-sectional view of the substrate of FIG. 3 undergoing further processing according to an embodiment of the present disclosure;

FIG. 5 is a cross-sectional view of the substrate of FIG. 4 undergoing further processing according to an embodiment of the present disclosure;

FIG. 6 is a cross-sectional view of the substrate of FIG. 5 undergoing further processing according to an embodiment of the present disclosure;

FIG. 7 is a cross-sectional view of the substrate of FIG. 6 undergoing further processing according to an embodiment of the present disclosure;

FIG. 8 is a cross-sectional view of the substrate of FIG. 7 undergoing further processing according to an embodiment of the present disclosure;

FIG. 9 is a cross-sectional view of the substrate of FIG. 8 undergoing further processing according to an embodiment of the present disclosure;

FIG. 10 is a cross-sectional view of the substrate of FIG. 9 undergoing further processing by irradiation with UV radiation according to an embodiment of the present disclosure;

FIG. 11 is a cross-sectional view of the substrate of FIG. 10 undergoing sintering according to an embodiment of the present disclosure.

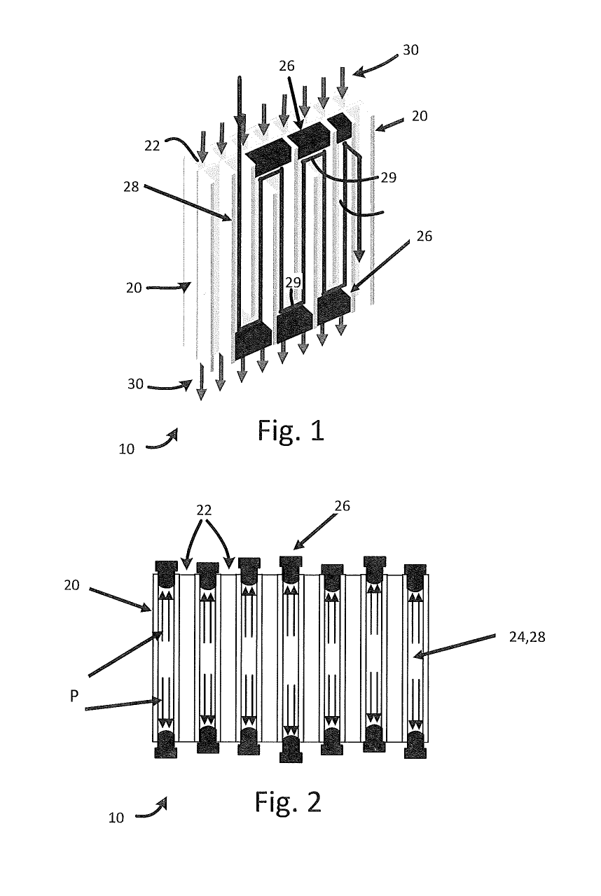

### DETAILED DESCRIPTION

Reference will now be made in detail to the accompanying drawings which illustrate certain instances of the methods and devices described generally herein. Whenever possible, the same reference numerals will be used throughout the drawings to refer to the same or like parts.

With respect to FIG. 2, glass frit materials used for plugging sintered alumina substrates, such as the material disclosed in EPO patent publication no. 2065347, for example, typically sinter at temperatures around 875° C. During substrate heating from room temperature to the sintering temperature, the plug material and substrate pass through the 100-150° C. temperature range. The plug material typically softens and becomes subject to deformation or dislocation under external applied force in this range. Experiments by or under direction of the present inventors have shown that plugs 26 often piston outward from their respective plugged or closed cells 24 during this phase of the sintering process, as shown in the cross section of FIG. 2. In all observed cases the plug “pistoning” results in plugs being partially ejected from end face channels of the substrate or honeycomb monolith 20.

Without intending to be bound by any particular theory, it is thought that heating of air within internal channels during substrate sintering produces a pressure build-up P that forces the plugs 26 outward. This pressure build-up P appears even though the internal, typically serpentine, channel or path 28 is not closed at each end, but is open to external ambient pressure via openings, typically in the form of side port holes (not shown). In a 5 cm (2-inch) diameter alumina substrate, internal channels can be up to 30 m long, so the distance to the open side port hole can be as much as 15 m through an approximately 1 mm square channel. Resistance to air flow down the path 28 during substrate sintering results in a pressure increase at interior locations within the path 28. Since the softened plugs 26 are unable to resist this local pressure build-up they are displaced out of substrate channels. Experiments have shown that plugs 26 are more likely to be pushed out toward the center of the substrate end face in regions, farthest away from open side port holes. Additional experiments show that the pistoning can be reduced by slowing the rate of substrate heating, but that it can not be eliminated for practical minimum heating rates (such as 25° C./hour, for example).

Since extensively long sintering times are undesirable, the plug pistoning problem makes it difficult to fabricate reactor substrates with plugs of uniform depth. This plug depth uniformity variation produces changes in channel geometry that induce reactant or heat exchange pressure and flow variations. Resulting variations in reactant temperature and residence time can affect reactor performance, reducing product yield and/or selectivity.

The present inventors have also found, through experiments performed and/or directed by them, that when plugging the second end face of a substrate 20, the high thermal conductivity of the (typically alumina) substrate 20 allows heat from the melted or softened plug material (and a hot plate used to heat it) to be rapidly transferred to air trapped in internal channels 24. The increase in air temperature results in a local pressure build-up that exists even though the internal channel is not closed at each end. The pressure drop along the channel or path 28 is large enough to create a local pressure that tends to push the heated plug material 26 out of substrate end face channels. As a result, the plug material 26 across the end face becomes loaded with trapped air bubbles that are undesirable. These problems recognized by the present inventors may be solved by the methods described below.

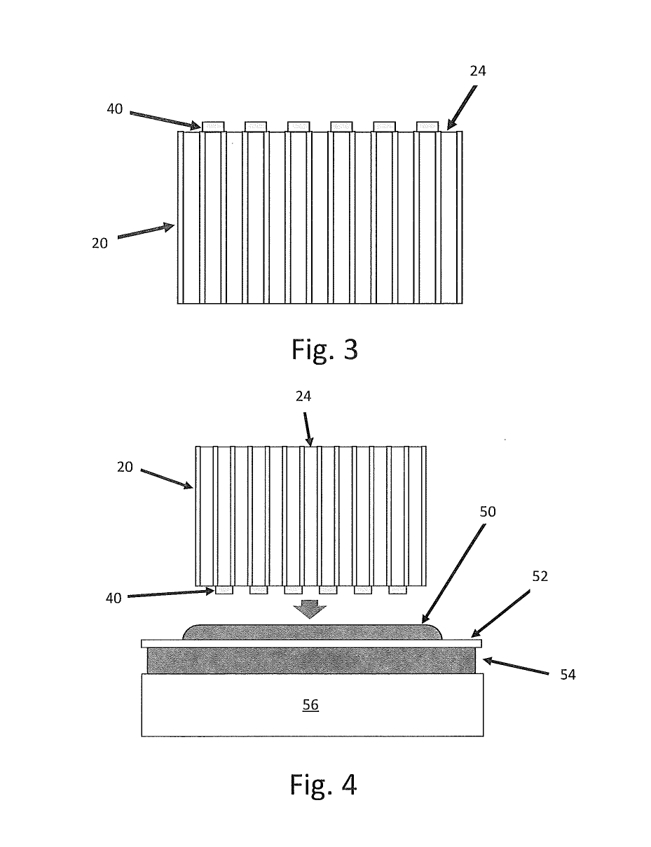

With reference to FIG. 3, a substrate 20 is plugged by first applying a plug mask 40 over selected channels 22 on one end face of the substrate 20. Masking may be provided by manually-applied tape strips or a laser cut mylar aperture. The plug mask 40 covers substrate channels 22 that must remain open after plugging, and leaves open the channels 24 that will be plugged.

With reference to FIG. 4, a thin layer of thermo-set based (wax-based or polymer-based) plug material 50 is placed on a non-stick film or other non-stick layer 52 (PTFE, for example) that rests in contact with a hot plate 54 on a support 56. One example plug composition is as follows: (1) 83.0 wt % glass powder as disclosed in EP 2065347; (2) 17.0 wt % wax binder (MX4462, CERDEC France).

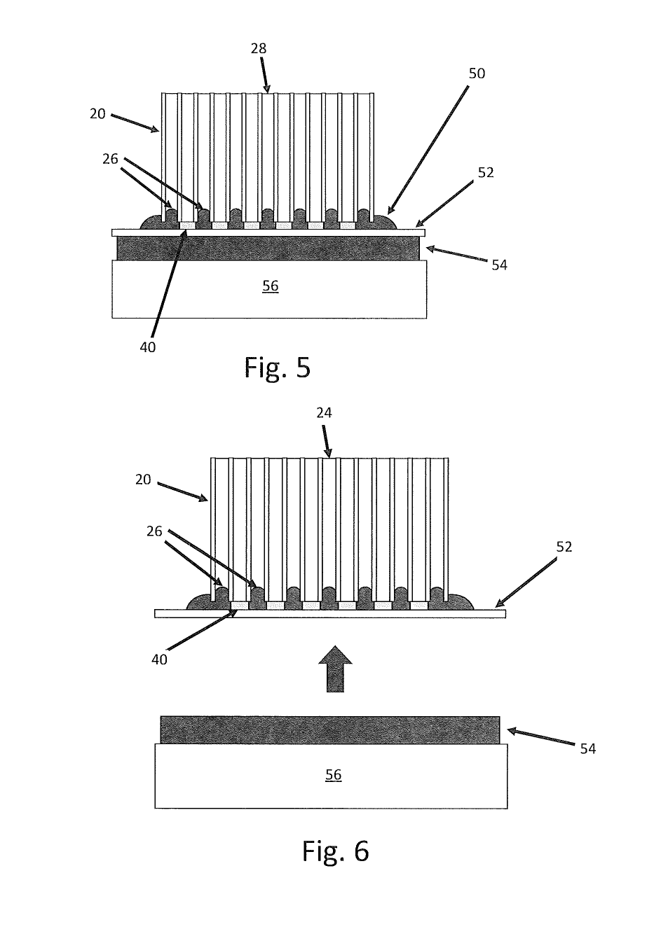

The hot plate 54 is heated to 100-125° C., causing the plug material 50 to melt into a disk on the surface of the non-stick film 52. A doctor blade (not shown) may be used to redistribute the plug material 50 into a thin sheet of uniform thickness. The masked end of the substrate 20 is then lowered onto the melted plug material 50, as seen in the cross section of FIG. 5. The substrate 20 can be preheated if needed to improve melted plug material flow during plugging.

With further reference to FIG. 5, melted plug material 50 flows into unplugged substrate end face channels 24 as the substrate 20 is lowered. Eventually the mask 40 comes into contact with the non-stick film 52, as shown. If needed, the substrate 20 can be held in contact with the hotplate 54 briefly through the film 52 to allow plug material 50 to self-level within each channel 24.

With reference to FIG. 6, next the substrate 20 and non-stick film 52 are removed from the hotplate 54. During this removal the non-stick film 52 remains in contact with the substrate end face and lateral translation of the non-stick film relative to the substrate end face is prevented.

Plug material 50 in substrate channels 24 generally cools and solidifies rapidly after removal from the hotplate 54. The time required for solidification can be reduced by placing the substrate 20 and non-stick film 52 on a flat surface that is at or near room temperature (not shown). After the plug material 50 solidifies the non-stick film 52 is removed from the substrate end face, as seen in the cross-section of FIG. 6. By removing the substrate 20 from the hotplate 54 for cooling, plugging process cycle time can be reduced, since extensive time for hotplate cool down and reheating (in preparation for the next part) is not required.

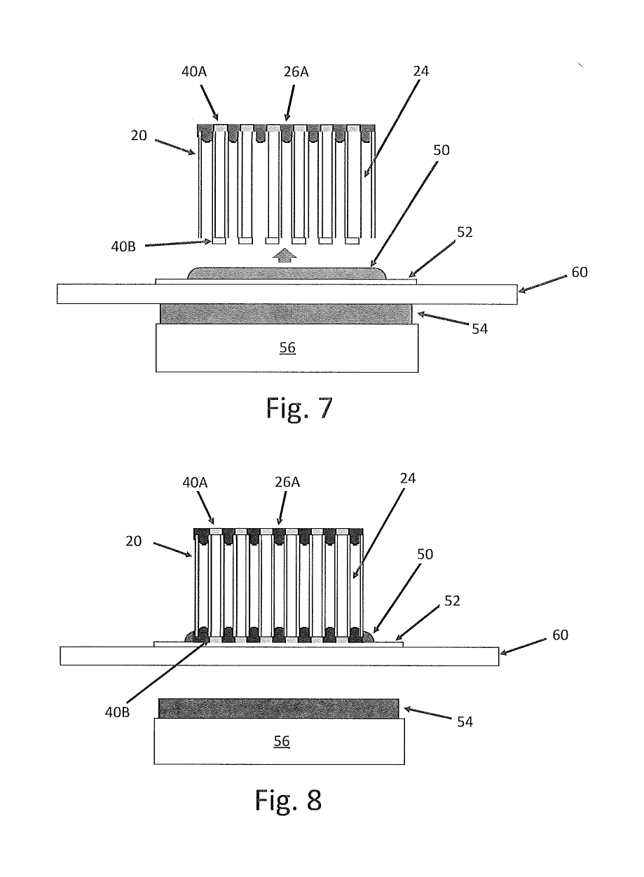

With reference to FIG. 7, next a glass plate 60 is placed in contact with a heated hotplate 54, and a sheet of non-stick film 52 is placed on top of the glass plate 60. As before, a thin layer of melted plug material 50 is formed on the non-stick film 52 via a doctor blade operation or the like (not shown).

With reference to FIG. 8, for this second set of plugs, the substrate 20 is plugged by raising the glass plate 60, non-stick film 52, and melted plug material 50 off the hot plate 54 and into contact with the unplugged substrate end face. Melted plug material 50 rapidly flows into all unmasked substrate end face channels 24.

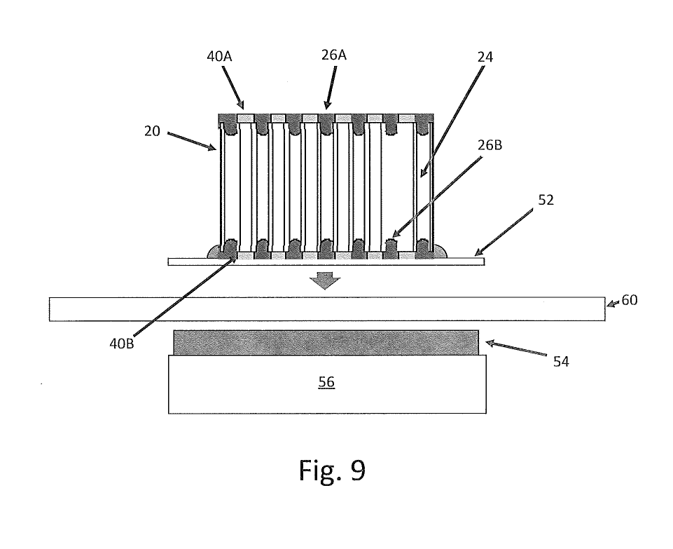

With reference to FIG. 9, the glass plate 60 is then immediately moved away from the substrate end face so that only the non-stick film 52 remains in contact with the substrate end face (16). This operation is carried out to prevent any significant heat transfer from the heated glass plate 60 to the substrate 20. When this heat transfer is prevented, heating of gas within the substrate channels 24 and resulting local pressurization is avoided. This prevents bubbles of air from being formed and pushing their way through the melted plug material 50. Use of glass as the material for the glass transfer plate 60 is beneficial in that glass generally has a combination of relatively low heat capacity of not more than 1.55 J/(cm3·K), and relatively low thermal conductivity of not more than 1.2 W/(m·K). Desirably, any other material in place of glass use for the plate 60 would meet or exceed these values.

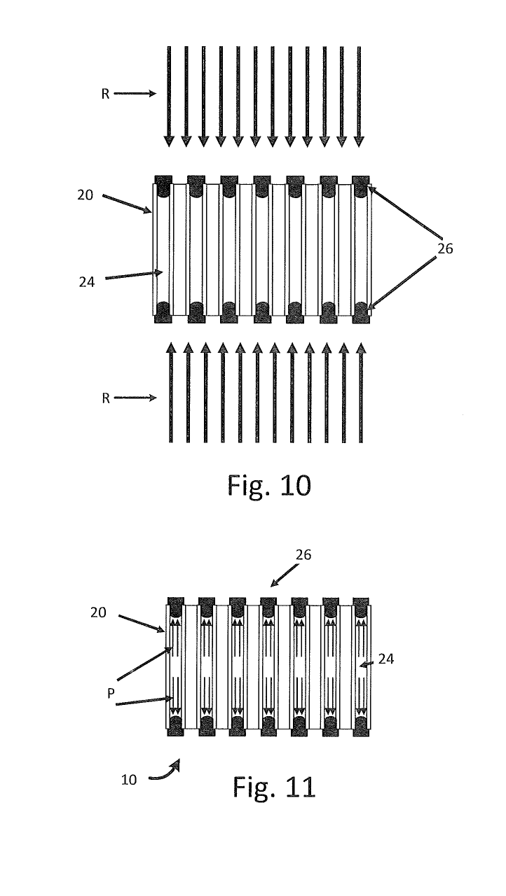

After the plug material cools the non-stick film 52 is removed from the substrate end face. With excess plug material around the perimeter of the substrate 20 removed, and after mask removal, the plugged substrate 20 appears in cross-section as shown in the central portion of FIG. 10.

As mentioned above, a major challenge in sintering of plugged substrates with long internal channels is prevention of plug pistoning. Plug pistoning may be eliminated by the UV-curable material in the glass frit polymer binder. An example plug material composition useful for alumina substrates is as follows: (1) 82 wt % glass powder as disclosed in EP 2065347 (with range 82 to 85 wt % dependent on particle size distribution [PSD]); (2) 15.3 wt % wax binder (MX4462) (with range 12 to 16 wt % dependent on PSD); (3) 2.7 wt % UV-curable binder (with range 2 to 5 wt %, dependent on PSD).

With further reference to FIG. 10, prior to sintering each substrate end face is exposed to UV radiation R. The UV-curable material cross-links and prevents plug material from softening during sintering through the 100-150° C. temperature range. Experiments have shown that sufficient plug material UV-curing is achieved after relatively brief exposure to UV radiation (1-2 minutes at 0.3 W/cm2) from a commercial UV source (for example, Green Spot, Model GS UV spot-curing unit).

With reference to FIG. 11, during sintering of the plug material, the UV-curable binder component does not soften prior to binder burnout, ensuring that plugs 26 remain in place and resist any local pressure buildup P in channels 24, resulting in a reliable, repeatable plug-formation process for plugs capable of resisting significant internal pressures within the resulting reactor 10. The methods and/or devices disclosed herein are generally useful in performing many chemical and physical fluid-based or fluid-borne processes, including any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

It will be apparent to those skilled in the art that various modifications and variations can be made without departing from the spirit or scope of the invention.

1. A method for plugging selected cells of a honeycomb monolith so as to form a fluidic reactor, the method comprising:
contacting selected cells of a honeycomb monolith with a melted or softened plug material comprising at least one sinterable particulate and a binder comprising at least one thermo-setting component and at least one UV-radiation curable polymer, such that a portion of the material remains in contact with the selected cells and plugs the selected cells;
cooling the melted or softened plug material such that the thermo-setting component sets;
after cooling, irradiating the portion of the material so as to at least partially cure the radiation curable polymer; and
after irradiating, sintering the portion of the material so as to remove the binder and so as to sinter the at least one sinterable particulate.

2. The method according to claim 1 further comprising removing at least a portion of the walls between at least some adjacent ones of the selected cells and wherein the selected cells and the removed portion of the walls are arranged such that, when the selected cells are plugged, one or more paths are formed within the monolith extending at least in part in a direction perpendicular to the cells of the monolith.

3. The method according to claim 1 further comprising removing at least a portion of the walls between at least some adjacent ones of the selected cells and wherein the selected cells and the removed portion of the walls are arranged such that, when the selected cells are plugged, one or more serpentine paths are formed within the monolith extending along the cells of the monolith.

4. The method according to claim 1 wherein the binder comprises at least 50% by weight of a thermoplastic polymer and at least 5% by weight of a radiation curable polymer.

5. The method according to claim 1 further comprising supporting the plug material during contacting with a substrate having a volumetric heat capacity of not more than 1.55 J/(cm³·K).

6. The method according to claim 1 further comprising supporting the plug material during contacting with a substrate having a thermal conductivity of not more than 1.2 W/(m·K).

7. The method according to claim 1 wherein the honeycomb monolith comprises glass, glass-ceramic, or ceramic.

8. The method according to claim 7 wherein the honeycomb monolith comprises alumina.

9. The method according to claim 1 wherein the at least one sinterable particulate is a glass.

10. A method for plugging selected cells of a honeycomb monolith so as to form a fluidic reactor, the method comprising:
providing a honeycomb monolith having a plurality of cells;
masking selected ones of the cells of the monolith not to be plugged;
contacting unmasked cells of the honeycomb monolith with a melted or softened plug material resting on a non-stick film supported on a refractory substrate having a volumetric heat capacity of not more than 1.55 J/(cm³·K) and a thermal conductivity of not more than 1.2 W/(m·K); and
after contacting for sufficient time to push the plug material into the unmasked cells, immediately removing the refractory substrate.

11. The method according to claim 10 wherein the plug material comprises at least one sinterable particulate and a binder comprising at least one thermo-setting component and at least one UV-radiation curable polymer, the method further comprising
cooling the melted or softened plug material in the monolith such that the thermo-setting component sets;
after cooling, irradiating the portion material in the substrate so as to at least partially cure the radiation curable polymer; and
after irradiating, sintering the portion of the material in the substrate so as to remove the binder and so as to sinter the at least one sinterable particulate.

12. The method according claim 10 further comprising removing at least a portion of the walls between at least some adjacent ones of the selected cells and wherein the selected cells and the removed portion of the walls are arranged such that, when the selected cells are plugged, one or more paths are formed within the monolith extending at least in part in a direction perpendicular to the cells of the monolith.

13. The method according claim 10 further comprising removing at least a portion of the walls between at least some adjacent ones of the selected cells and wherein the selected cells and the removed portion of the walls are arranged such that, when the selected cells are plugged, one or more serpentine paths are formed within the monolith extending along the cells of the monolith.

14. The method according to claim 10 wherein the honeycomb monolith comprises glass, glass-ceramic, or ceramic.

15. The method according to claim 10 wherein the at least one sinterable particulate is a glass.
